(19) United States
(12) Patent Application Publication
(10) Pub. No.: US 2007/0169045 A1
(43) Pub. Date: Jul. 19, 2007

(54) Component tagging

(75) Inventors: Elsie Nallipogu, Seattle, WA (US); Frederic O. Vicik, Sammamish, WA (US); Michael R. Fortin, Redmond, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/291,864

(22) Filed: Dec. 1, 2005

(51) Int. Cl. G06F 9/45

(52) U.S. Cl. 717/151

(57) ABSTRACT

A component tagging system for tagging various components and sub-components used by various processes allows creating a plurality of component tags for various components used in processes in a manner so that the component tags may be used in tracking various resources used by the components. The component tagging system also allows tracking usage of resources by various threads in process thread-pools, wherein the various threads may perform a service or a function on behalf of the components. An alternate embodiment of the component tagging system allows tagging of multi-process components wherein the multi-process components may be used to perform a service or a function across multiple processes.

### BACKGROUND

Computers and computer software make up a very important part of modem life and business. In today's business environment, for any organization to stay competitive, it is imperative that it use computers and software applications to manage data, customers, employees, finances, etc. Businesses use a number of different software applications for virtually every function of their daily operations, such as payroll, customer relation management (CRM), accounting, inventory management, etc. Each of these various software applications generally comprise a number of different processes that work together to provide the software application its functionalities. Moreover, operating systems manage various computer applications and also use a number of processes to coordinate functioning of the software applications.

For example, in the Windows™ operating system a single process may be used to host a plurality of Windows™ services and to manage a plurality of dynamic link libraries (dll) that each service may load. At startup of a computer, the svchost process may check a services portion of a computer's registry to construct a list of services that need to be loaded on to the computer's random access memory from hard drive or other memory location. Generally, multiple instances of the svchost process may be running at the same time with each svchost process containing a group of services or components so that each separate service or component can be run depending on how and where the svchost process was started.

Creating and maintaining various processes is generally expensive as each additional process consumes scarce resources, including virtual memory, communication resources, available communication ports, sockets, etc. This is specifically important in the case of operating systems, as operating systems, such as Windows™, LINUX™, etc., employ a large number of processes to perform various operating system functions and to manage various applications supported by such operating system.

Generally speaking, operating systems are updated on a continuous basis, and with each release of a newer version of an operating system, newer processes are added to the operating systems to perform newer functionalities, to support newer applications, etc. However, quite often, processes used in previous version of the operating system may not be easily discarded as such processes may be used to continue providing support to previously provided functions, older versions of software applications, etc. As a result, with introduction of each newer version of an operating system, the creation and management of all the processes becomes more complex and expensive.

In order to reduce the number of resources used by the various processes running on a system, quite often various components of these processes share various resources. However, when various components share various resources, it is difficult to track actual resource usage by each of these individual components. Moreover, in such a situation it is not possible to identify which component in a given process is using a resource. For example, when a resource shared by various processes is affected or when a resource shared by various processes needs to be removed, rationed, etc., it is necessary to know which components are using such a resource. An example of a specific need to track such resource usage may be to identify, for security purposes, the components in a process that have specific ports open and to use that information to control which port can be used by a given component.

Another example of another specific need to track such resource usage may be to identify, for reliability purposes, components in a process that have opened a specific DLL or a file and then using that information to shutdown only those components to release that specific DLL or a file. Identifying such information allows the system to avoid shutting down all components in a process and it may also allow a system to avoid a computer shutdown, thus increasing the uptime of the system. Yet another example of a specific use of tracking resource usage by various components may be to enhance performance of one or more of the various processes by limiting or controlling resource usage by largest consumer processes. Thus, there is a need to provide resource usage at a component level to improve performance of operating systems.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A component tagging system for tagging various components and sub-components used by various processes allows creating a plurality of component tags for various components used in processes in a manner so that the component tags may be used in tracking various resources used by the components. The component tagging system also allows tracking usage of resources by various threads in process thread-pools, wherein the various threads may perform a service or a function on behalf of the components. Various threads in a thread-pool of a given process may be shared by all components in that process.

An alternate embodiment of the component tagging system allows tagging of multi-process components wherein the multi-process components may be used to perform a service or a function across multiple processes. Such a multi-process component tagging system may allow accounting of various resources used by the components even when such components may be providing services across various processes. For example, using the component tagging system allows a computer system to determine which of the various resources are highly used and which resources often have higher backed up demand. The resource accounting provided by the component tagging system may also be used to determine which components and processes are affected by a change in a resource and therefore, need to be restarted upon implementing such a change. Alternatively, the resource accounting may also be used to identify casual components related to various failures in the system, such as memory leaks, system crashes, etc.

An embodiment of the component tagging system includes a component tag creator module that is used to create tags for various components and propagates the component tags to various processes for which such components are used. The component tags are attached to each of the various components. When a component requests a resource, a resource manager collects and records the component tag attached to the requestor component into a resource accounting system. The resource manager allocates the resource based on the status of the requested resource, such as the number of component tags recorded for the requested resource, etc. Alternatively, when a thread performing a service for a component requests a resource, similar accounting recording of the component tag attached to the resource requesting thread may also be performed.

### BRIEF DESCRIPTION OF DRAWINGS

The present patent is illustrated by way of examples and not limitations in the accompanying figures, in which like references indicate similar elements, and in which:

FIG. 1 is a block diagram of a network interconnecting a plurality of computing resources;

FIG. 2 is a block diagram of a computer that may be connected to the network of FIG. 1;

FIG. 3 illustrates a block diagram of a component tagging system;

FIG. 4 is an exemplary flowchart illustrating creation and attachment of component tags by the component tagging system of FIG. 3; and

FIG. 5 is an exemplary flowchart illustrating accounting of component tags by a resource manager used by the component tagging system of FIG. 3.

### DETAILED DESCRIPTION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims defining the invention.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

### NETWORK

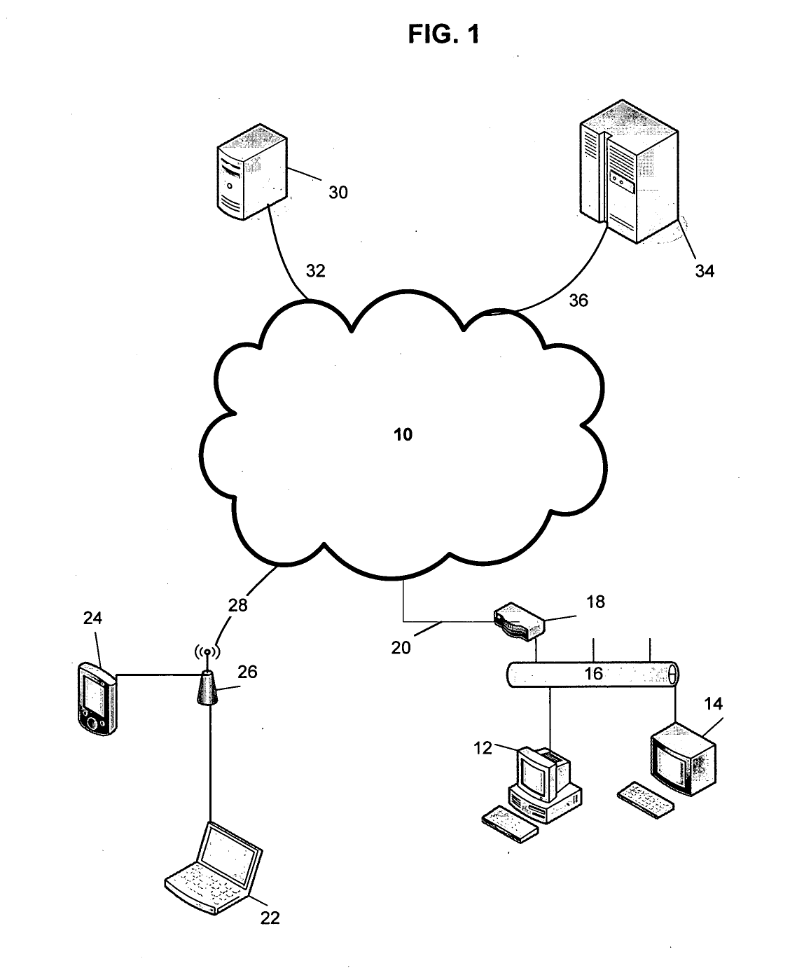

FIG. 1 illustrates a network 10 that may be used to implement a component tagging system described herein. The network 10 may be the Internet, a virtual private network (VPN), or any other network that allows one or more computers, communication devices, databases, etc., to be communicatively connected to each other. The network 10 may be connected to a personal computer 12 and a computer terminal 14 via an Ethernet 16 and a router 18, and a landline 20. On the other hand, the network 10 may wirelessly connected to a laptop computer 22 and a personal data assistant 24 via a wireless communication station 26 and a wireless link 28. Similarly, a server 30 may be connected to the network 10 using a communication link 32 and a mainframe 34 may be connected to the network 10 using another communication link 36. As it will be described below in further detail, one or more components of the sub component tagging system may be stored and operated on any of the various devices connected to the network 10. For example, the component tagging system described in here may include a resource manager located on the mainframe 34 and various processes implemented on the personal computer 12.

### COMPUTER

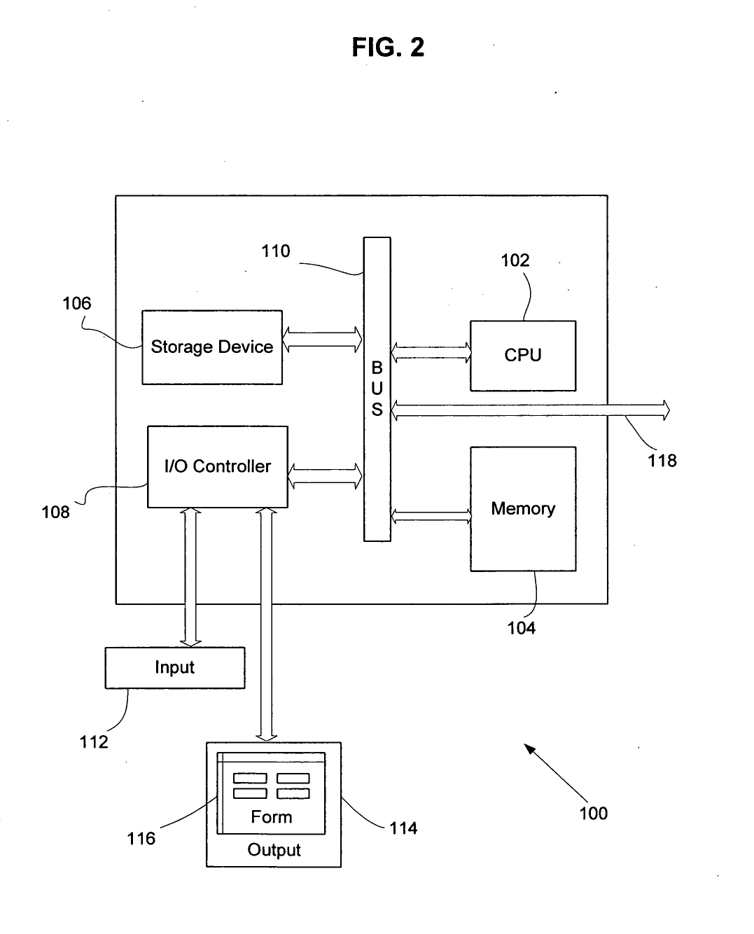

FIG. 2 illustrates a computing device in the form of a computer 100 that may be connected to the network 10 and used to implement one or more components of a component tagging system described herein. Components of the computer 100 may include, but are not limited to a central processing unit (CPU) 102, a memory 104, a storage device 106, an input/output controller 108, and a system bus 110 that couples various system components including the memory to the CPU 102. The system bus 110 may be any of several types of bus structures including a memory bus or memory controller, a peripheral bus, and a local bus using any of a variety of bus architectures.

The memory 104 may include computer storage media in the form of volatile and/or nonvolatile memory such as read only memory (ROM) and random access memory (RAM). A basic input/output system (BIOS), containing the basic routines that help to transfer information between elements within computer 110, such as during start-up, is typically stored in ROM. RAM typically contains data and/or program modules that are immediately accessible to and/or presently being operated on by processing unit 120. The memory 104 may also be used to store data related to one or more components and resources used by the computer 100.

The storage device 106 may typically include removable/non-removable, volatile/nonvolatile computer storage media. By way of example only, the storage device 106 may include a hard disk drive, a magnetic disk drive, nonvolatile magnetic disk, an optical disk drive, etc. One or more of the forms stored on the memory 104 may be populated using data stored on the storage device 106. The I/O controller may be used by the computer 100 to communicate with an input device 112, which may be a keyboard, a mouse, etc., an output device 114, which may be a monitor, a printer, etc.

### COMPONENT TAGGING SYSTEM

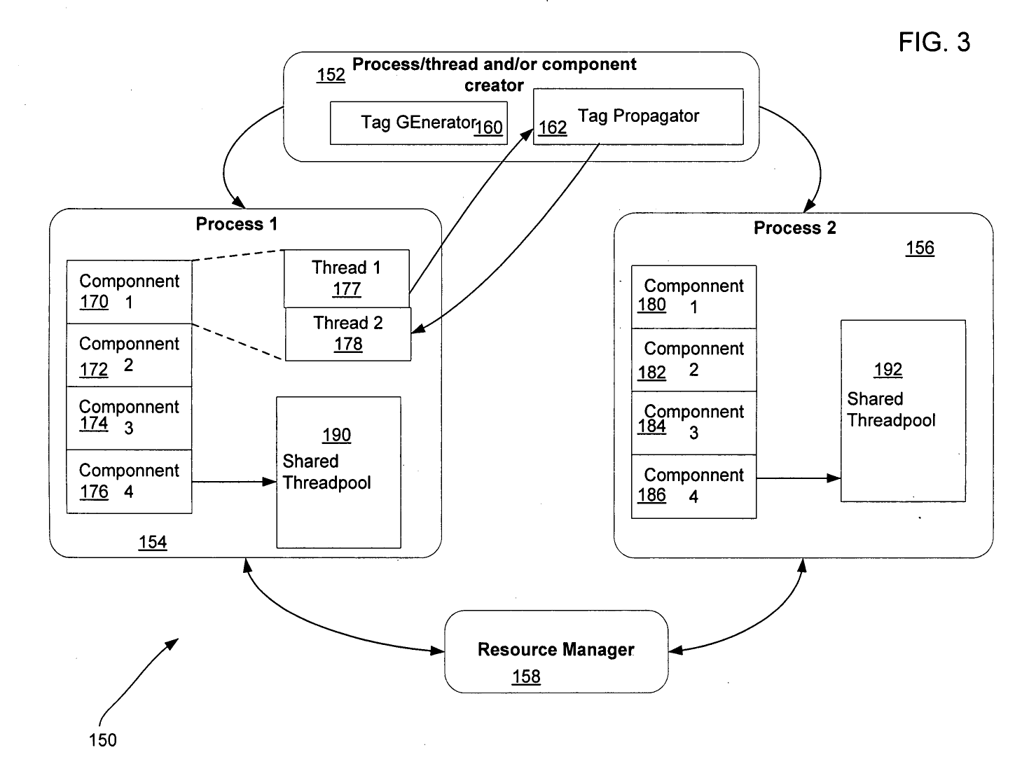

FIG. 3 is an illustration of a component tagging system 150, which may be implemented on a computer such as the computer 100. The component tagging system 150 includes a process/thread and/or component creator module 152, a first process 154, a second process 156 and a resource manager 158. The component tagging system 150 may be implemented, either in a RAM portion or a ROM portion of the memory 104 of the computer 100. In the illustrated implementation, each of the processes 154-156 are implemented on the same computer 100, however, in an alternate embodiment, the processes 154-156 may be implemented on different computers/devices located on different nodes of the network 10. Alternatively, the process/thread and/or component creator module 152 may be located on a central server, such as the server 30 and the processes 154-156 may be implemented on remote client computers. As one of ordinary skill in the art would appreciate, a number of different nodes on the network 10 may be used to implement various modules of the component tagging system 150.

The process/thread and/or component creator module 152 may be responsible for generating various processes that may be implemented on the computer 100. For example, the process/thread and/or component creator module 152 may be responsible for generating various processes for an operating system running on the computer 100. Moreover, a component may also be responsible for generating a thread on the system. The process/thread and/or component creator module 152 also includes a component tag generator module 160 and a component tag propagator module 162. The tag generator module 160 may be responsible for generating tags for each of the various components used in each of the various processes generated by the process/thread and/or component creator module 152. Moreover, once a tag is created, it may be added to the metadata of a process or the metadata of a thread. For example, in the Windows™ operating system, a tag for a particular component may be added to a thread environment block (TEB) of the first thread started for that particular component. While the tag propagator module 162 may propagate such component tags to the various processes, such as the processes 154-156. Moreover, the tag propagator module 162 may also propagate the component tags to other processes over the network 10, such as a remote procedure call (RPC) process, etc. Moreover, the tag propagator module 162 may also propagate a component tag to other threads, such as, for example, when a first thread creates a second thread, the component tags related to the first tag are propagated to the second thread.

In the illustrated implementation, the first process 154 is illustrated to have a plurality of components 170-176. Each of the components 170-176 may have one or more threads. For example, the component 170 has two threads 177-178. Moreover, each of the components 170-176 may also share threads from a common thread-pool. The first process 154 may be, for example an svchost process used by an operating system, such as the Windows™ operating system, whereas the components 170-176 may be, for example, a scheduler component, a group policy server component, a print spooler component, a web service component, an automatic update service component, an error reporting service component, a plug-and-play service component, etc. The second process 154 may be, for example, an svchost process, etc. While the components 180-186 of the second process 156 may be different than the components 170-176 of the first process 154, depending on the processes 154-156, some of these components 170-176 and 180-186 may be common between the first process 154 and the second process 156.

Many computer applications create threads that can be used to post work items, process asynchronous input/output requests etc. Generally speaking, such threads spend a great deal of time in the sleeping state, waiting for an event to occur. Thread-pools are a pool of worker threads managed by a system and they allow applications to queue or request a work item from a pool of threads that be shared by all components in a process. Each of the process 154-156 may include shared thread-pools 190 and 192, respectively, wherein the shared thread-pools 190-192 may include a plurality of threads providing services to the plurality of components 170-176 and 180-186. For example, two or more of the components 170-176 may use a returnPrt thread that may be used to return a communication port number to the requesting component.

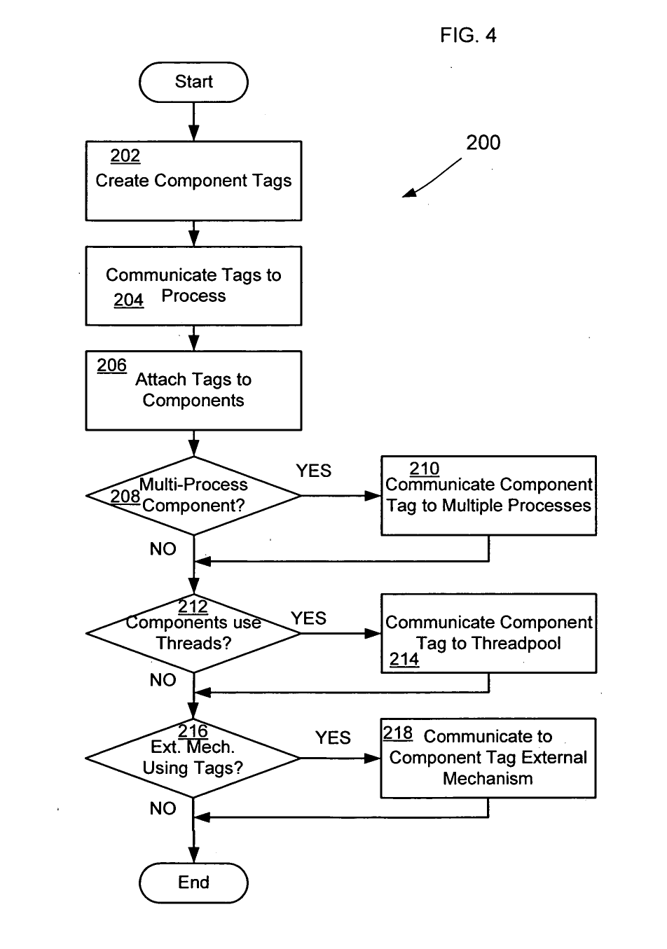

Now turning to FIG. 4, an exemplary flowchart illustrates functioning of a component tag attachment routine 200 that may be used by the component tagging system 150. At a block 202 the tag generator module 160 may generate component tags for various components used by one or more processes used in the component tagging system 150. The tag generator module 160 receives the list of processes that may be used in the component tagging system 150 from the process/thread and/or component creator module 152. A component tag generated by the tag generator module 160 may be unique numeric identifier that is specific to the component. For example, a 16 bit, a 32 bit, or a 64 bit identifier may be used as a component tag to identify each component. Such a unique identifier may be selected using any of the various well known methods, such as global unique identifier (GUID), etc.

Subsequently, at a block 204, the tag propagator module 162 propagates the tags to appropriate process that uses the component. Herein, the term tag propagation is used to refer to communicating the tag to the process/thread using the component, making the tag available to the process/thread using that component, propagating the tag along with a work item when a task is handed off or subdivided, etc. For example, a component which performs a task on behalf of another component temporarily attaches the tag from the work item to itself. Subsequently, if the task is further subdivided, the tag is propagated further. For example, as the first process 154 uses the component 170, the component tag for component 170 may be propagated to the first process 154. Subsequently, at a block 206, the component tag may be attached to the component. Attaching a component tag to a component may be as simple as merely storing the tag in a table having component identifiers as a key. Alternatively, the component tags may be added to the metadata of the component structure, etc. One of ordinary skill in the art can easily implement various methods of attaching a tag to a component. In an alternate implementation of the process/thread and/or component creator module 152, component tags may be attached to the components at the time of generating such components.

Subsequently, a block 208 determines if a component is used in a multiple process environment. For example, component 170 may be the same as the component 180 and instead of having duplicate components, the second process 156 may call upon the component 170 from the first process 154. In such a case, a block 210 may communicate the component tag of the component 170 to the second process 156. Such propagating of the component tags to multiple processes may be necessary when the component tags are stored in each process in a store, such as a relational table relating various components to their component tags. However, alternate methods of tag storage, well known to one of ordinary skill in the art, may also be employed.

Subsequently, a block 212 determines if a process uses a thread-pool containing a plurality of threads which may be called upon by one or more components to perform a service on behalf of such components. For example, thread-pool 190 and the thread-pool 192 may be used to perform various services for the components in their corresponding processes. In such a case, a block 214 may propagate the component tags to the corresponding thread-pools, where such component tags may be stored in a manner so that when a thread requests a resource from the resource manager 158, the resource manager 158 checks to see if a tag was provided. If so, then the resource manager 158 records the tag and uses it for tag accounting, or to deny the resource requested by the thread.

Subsequently, a block 216 determines if any external mechanism, such as an external computer, may call upon any of the components having component tags. Such an external computer may be located on the network 10 or any other network connected to the network 10 via, for example, the Internet. For example, a remote procedure call (RPC) routine on the network 10 may call upon one of the components having the components tags. In such a case, a block 218 may propagate appropriate component tags to such external mechanism.

As one of ordinary skill in the art would appreciate, not all the blocks of the component tag attachment routine 200 need to be performed for a given implementation of the component tagging system 150. As some of the blocks of the component tag attachment routine 200 may be used primarily to increase the efficiency of the component tag attachment routine 200, one or more such blocks may be omitted in a given implementation without affecting the functionality of the component tagging system 150. Moreover, one or more of the blocks in the component tag attachment routine 200 may also be implemented in an alternate order without affecting the functionality of the component tagging system 150.

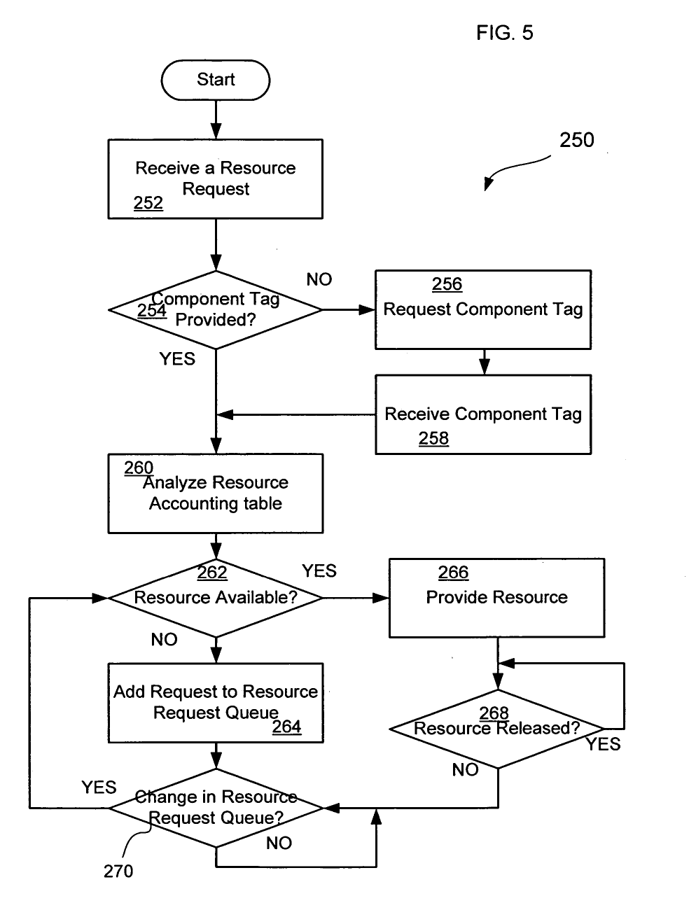

Now referring to FIG. 5, an exemplary flowchart illustrates functioning of a component tag accounting routine 250 that may be used by the component tagging system 150. The component tag accounting routine 250 may be implemented in the resource manager 158 of the component tagging system 150. The resource manager may be responsible for allocating various resources to various processes, various components within the processes, etc. For example, the resource manager 158 may receive request for resources from processes 154-156 via the internal communication bus 110, from external mechanisms via external communication bus 118, etc. The resource manager 158 may be responsible for allocating memory blocks, communication ports, CPU 102 time, usage of various registers on the CPU 102, etc.

At a block 252, the resource manager 158 receives such a request for a resource from, for example, the first process 154. Any of the various components 170-176 may have generated such a resource request. Alternatively, a thread from the thread-pool 190 may also have generated such a request for a resource. At a block 254, the resource manager 158 determines whether the request for resource includes any component tag. If no component tag is included with the request for resource, a block 256 may request the component tag from the requesting process, from the requesting component, from the requesting thread, etc. Subsequently, a block 258 may receive such a component tag from the source of request.

The resource manger 158 may be designed in a manner such that if no component tag is returned from the source of request, the resource manager may deny the resource. In such a situation the source of request may generate an error message or generate a call back to its parent process to request the component tag. For example, if a thread within the thread-pool 190, performing a service for component 170 does not have a component tag, it may generate a request for the component thread to the component 170.

Upon receiving the component tag, a block 260 may analyze a resource accounting store for the requested resource. For example, the block 260 may evaluate the accounting store for the requested resource to determine how many components are currently using the requested resource, how much of the requested resource is currently available, etc. For example, the requested resource may have a quota allocated per component, per process, per computer, etc., and if the allocated quota is already in use, the request for the resource ma be denied. As one of ordinary skill in the art would know any number of other alternate criteria may be used to deny or to allow allocation of the requested resource. For example, such a criteria may specify a maximum number of component tags that may be attached to a requested resource. Alternatively, such a criteria may also specify an allocation mechanism for allocating resources in case all resource requests cannot be met.

In an alternate embodiment, the resource accounting store may be used for providing efficient updates to the operating system. In such an embodiment, the resource manager 158 may analyze the resource accounting store attached to the requested resource, determine the operating system related components that affect any resource related to an operating system, shut down the operating system related components, update the operating system, and restart the operating system related components after completing the update to the operating system. Such a system allows providing updates to operating systems while reducing the components in each process that are shut down.

A block 262 determines whether the requested resource is available for the source of request (component, thread, etc.). If the requested resource is not available, a block 264 may add the request for the resource to a resource request queue and notify the source of request that the requested resource is temporarily not available. On the other hand, if the requested resource is currently available, a block 266 may provide such resource to the source of request. Subsequently, a block 268 periodically monitors the use of the requested resource to see if any of such requested resource is released or not. A block 270 periodically analyzes the resource request queue to determine whether any released resource needs to be allocated to any requesting source.

As one of ordinary skill in the art would appreciate, not all the blocks of the component tag accounting routine 250 need to be performed for a given implementation of the component tagging system 150. As some of the blocks of the component tag accounting routine 250 may be used primarily to increase the efficiency of the component tag accounting routine 250, one or more such blocks may be omitted in a given implementation without affecting the functionality of the component tagging system 150. Moreover, one or more of the blocks in the component tag accounting routine 250 may also be implemented in an alternate order without affecting the functionality of the component tagging system 150.

The component tag accounting routine 250 may also analyze the resource accounting store to determine utilization rates of various resources, to determine which components are utilizing which resources at higher rate, etc. Alternatively, the component tag accounting routine 250 may also report resource utilization rates to computer administrators to aid in debugging. Thus, the Performance Analysis Monitor of the Windows™ operating system may show which components are using the most of the CPU resource. For example, in an implementation, the component tag accounting routine 250 may also generate a report to the system user recommending increased availability of certain resources, such a communication ports, CPU registers, etc.

Moreover, the component tagging system 150 may also be used to identify how to reclaim a resource in response to a computer reboot or shutdown. For example, the component tagging system 150 may shutdown a component to release a dll, ask a component to unload a dll (i.e., without stopping the component functioning), and then update a dll without requiring a system reboot, etc. Such calls on components may be performed also when a resource is exhausted, in which case components identified as using the exhausted resource may be asked to release the resource, or the operating system may be notified to close such components either forcibly or using an agreed upon or known procedure.

The component tagging system 150 may also use the resource accounting stores for various resources to determine which components are to be terminated in response to an alarm, an emergency shutdown, a reboot of the computer system, etc. Alternatively, the component tagging system 150 may also use the resource accounting store for various debugging functions, such as, to determine which component caused a memory leak, to aid in identifying causes of a process crash/hang/malfunction, etc.

For example, if at any given point if there is a change that need to be incorporated in a particular dynamic link library (dll), the component tagging system may use the resource accounting store for that particular dll to determine which components, and therefore, which processes need to be shutdown and restarted to effectuate the update in the dll. In an alternate case, if a particular computer system using the component tagging system 150 is forced in an automatic shutdown, the component tagging system 150 may store the current status of the resource accounting stores in a non-volatile memory in a manner so as to use it upon rebooting of the computer system.

Although the forgoing text sets forth a detailed description of numerous different embodiments of the invention, it should be understood that the scope of the invention is defined by the words of the claims set forth at the end of this patent. The detailed description is to be construed as exemplary only and does not describe every possible embodiment of the invention because describing every possible embodiment would be impractical, if not impossible. Numerous alternative embodiments could be implemented, using either current technology or technology developed after the filing date of this patent, which would still fall within the scope of the claims defining the invention.

Thus, many modifications and variations may be made in the techniques and structures described and illustrated herein without departing from the spirit and scope of the present invention. Accordingly, it should be understood that the methods and apparatus described herein are illustrative only and are not limiting upon the scope of the invention.

What is claimed is:

1. A method of providing component tagging for a plurality of components within a computer process, comprising:
creating a plurality of electronic component tags, each component tag corresponding to one of a plurality of components;
propagating each of the plurality of tags to the computer process; and
attaching each of the plurality of component tags to the one of the corresponding components.

2. A method of claim 1, further comprising:
requesting a resource by a requester component;
in response to the request, requesting a requester component tag from the requestor component;
adding the requestor component tag to a resource accounting store corresponding to the requested resource; and
providing the requested resource to the requestor component.

3. A method of claim 2, wherein providing the resource to the requestor component comprises analyzing a plurality of component tags attached to in the resource accounting store corresponding to the requested resource based on a criteria and providing the requested resource if the criteria is met.

4. A method of claim 3, wherein the criteria specifies at least one of: (1) a maximum number of component tags that may be attached to a requested resource; and (2) an allocation mechanism for allocating resources in case all resource requests cannot be met.

5. A method of claim 2, wherein the requested resource is at least one of: (1) a dynamic link library; (2) a communication port; (3) a memory block; (4) a CPU; and (5) an input/output resource.

6. A method of claim 2, wherein the plurality of components includes at least one of: (1) a scheduler; (2) a group policy server; (3) a print spooler; (4) a web service; (5) an automatic update service; (6) an error reporting service; and (7) a plug-and-play service.

7. A method of claim 1, further comprising propagating the plurality of component tags to a thread-pool comprising a plurality of threads, wherein at least some of the plurality of threads provide services to one or more of the plurality of components.

8. A method of claim 3, further comprising:
requesting a resource by a requestor thread of the plurality of threads;
in response to the request from the one of the plurality of threads, requesting a requestor thread tag from the requestor thread;
propagating a component tag attached to the requestor thread to a resource manager; and
adding the component tag communicated by the requestor thread to the resource accounting store corresponding to the requested resource.

9. A method of claim 1, wherein the plurality of components includes a multi-process component used to provide a plurality of services within a plurality of processes.

10. A method of claim 9, further comprising propagating a component tag related to the multi-process component to each of the plurality of processes.

11. A computer-readable medium containing computer code for implementing a plurality of processes on a computer system, each of the plurality of processes including a plurality of components for performing various services for the plurality of processes, the computer readable medium further comprising:
a component tag creator routine adapted to create component tags for each of the plurality of components;
a component tag propagator routine adapted to propagate the component tags to each of the plurality of processes;
a component tag manager routine adapted to attach the plurality of component tags to the plurality of components;
a resource requestor routine adapted to generate a resource request for a requestor component; and
a resource manager routine adapted to receive the resource request and, in response to the resource request, to request a requestor component tag attached to the requestor component, to add the requestor component tag to a resource accounting store corresponding to the requested resource, and to provide the requested resource to the requestor component.

12. The computer-readable medium of claim 11, wherein the resource manager routine is further adapted to:
analyze the resource accounting store attached to the requested resource;
determine the operating system related components that affect any resource related to an operating system;
shut down the operating system related components;
update the operating system; and
restart the operating system related components after completing the update to the operating system.

13. The computer-readable medium of claim 11, further comprising:
a thread-pool manager routine adapted to manage a plurality of threads, each of the plurality of threads providing a service to one or more of the plurality of components; and
a thread resource requester. routine adapted to communicate a request for a resource to the resource manager routine, the request including a component tag corresponding to a component using the one of the plurality of threads.

14. The computer-readable medium of claim 13, further comprising saving the resource accounting store in response to an automatic shutdown of the computer system.

15. A component tagging system for tagging a plurality of components used by a plurality of computer processes, the system comprising:
an electronic component tag generator adapted to generate a plurality of component tags, each component tag corresponding to one of a plurality of components and to propagate each of the plurality of component tags to a plurality of processes employing the plurality of components;
the plurality of processes adapted to attach each of the plurality of component tags to its corresponding component; and
a resource manager adapted to:
receive a request from requestor component of the plurality of components for a resource,
request the component tag of the requestor component,
add the component tag of the requestor component to a resource accounting store corresponding to the requested resource, and
provide the resource to the requestor component.

16. A component tagging system of claim 15, wherein the resource manager is further adapted to:
receive a request for a resource from a requestor thread;
request the component tag of a component corresponding to the requestor thread;
add the component tag of the requestor thread to a resource accounting store corresponding to the requested resource; and
provide the resource to the requestor thread.

17. A component tagging system of claim 15, wherein the resource manager is further adapted to analyze the accounting store corresponding to the requested resource before providing the resource to the requestor component.

18. A component tagging system of claim 15, wherein the requested resource is at least one of: (1) a dynamic link library; (2) a communication port; (3) a memory block; (4) a CPU; and (5) an input/output resource.

19. A component tagging system of claim 15, wherein each of the plurality of processes includes a thread-pool comprising a plurality of threads, wherein at least some of the plurality of threads provide services to one or more of the plurality of components.

20. A component tagging system of claim 15, wherein each of the plurality of processes is further adapted to attach each of the plurality of threads with a component tags corresponding to one of the plurality of components.
